(19) United States
(12) Patent Application Publication
(10) Pub. No.: US 2005/0111011 A1
(43) Pub. Date: May 26, 2005

(54) Probe for non-destructive testing

(76) Inventors: Laurence Philip Dickinson, Carlingford (AU); Suszanne Thwaites, Lindfield (AU); Stewart Wagner, Richmond (AU); Vivonne Thwaites, Henley Beach (AU)

Correspondence Address: LADAS & PARRY LLP, 224 SOUTH MICHIGAN AVENUE, SUITE 1200, CHICAGO, IL, 60604, US

(21) Appl. No.: 10/967,467

(22) Filed: Oct. 18, 2004

Related U.S. Application Data
(63) Continuation-in-part of application No. 10/688,755, filed on Oct. 17, 2003.
Application No. 10/688,755 is a continuation-in-part of application No. PCT/AU02/00494, filed on Apr. 19, 2002.

(30) Foreign Application Priority Data
Apr. 20, 2001 (AU) PR 4507
Nov. 23, 2001 (AU) PR 9083
Dec. 13, 2001 (AU) PR 9516

(51) Int. Cl. G01N 21/84; G01B 11/14; G01B 11/26; G01B 11/00

(52) U.S. Cl. 356/614; 73/866.5; 250/559.29; 356/615

(57) ABSTRACT

The present invention provides a probe for non-destructive testing of items. The probe is movable over a surface of a test item and includes a displacement sensor means for providing a displacement signal indicative of the spatial displacement of the probe over the test item as the probe is moved over the test item. The invention also provides the above-defined probe with a receiver for receiving a return signal from the non-destructive testing of the item and a non-destructive testing system comprising the probe.

### FIELD OF INVENTION

The present invention relates to a probe for use in the non-destructive testing of materials, and, particularly, but not exclusively, to a probe for use in the non-destructive testing (NDT) of structures and composite materials.

### BACKGROUND OF THE INVENTION

Non-destructive testing (NDT) is used to test a number of materials, in particular composite materials, such as utilised to manufacture aircraft and other items. It is not feasible to test items such as an aircraft for damage by disassembling the aircraft first. The testing needs to be non-destructive. Generally, but not exclusively, acoustic and near ultrasonic frequencies are used for NDT.

A typical NDT system is the pitch/catch system, employing a pitch/catch probe. A schematic cross-section through a typical pitch/catch probe showing the fundamental elements of such a probe is illustrated in FIG. 4. The pitch/catch probe 20 includes first 21 and second 22 probe assemblies. The probe assemblies include respective contact tips 23 and 24 which are spring loaded by springs 25 and 26 to contact a test sample 27. Each probe assembly 21 and 22 is equipped with a transducer 28, 29 such that one can act as a driver and the other as a detector (the operation may be interchangeable). The available drive frequency range is wide, typically 1 to 70 kHz. The drive signal is generally a short wave train, up to 6 cycles of sinusoid at a user selected frequency within the above range. The drive signal may alternatively be impulse or step excitation. The detector measures a response of the test sample 27 at its contact point. The theory is that the propagation of the disturbance from the drive to the detector is influence by the nature of the intervening structure and in particular, by any damage or anomaly in this region.

A return signal detected from a damaged test sample is compared with that from a “good” test sample (to give a reference signal) to determine the extent of any damage to the test sample. In conventional systems, complex electronic hardware is utilised to process the signals and provide a display of the return signal to enable determination of the damage. These systems are often expensive and the equipment is usually bulky.

In operation, testing will actually be carried out in situ on the item being tested (for example, an aeroplane). The pitch/catch probe is passed over the surface of the panels of the item being tested, and readings are taken from a plurality of points across the panel. Typical pitch/catch probes are hand held and move from one place to another over material being tested whilst viewing the result on a graphical readout.

Often, a reference frame is required so that positional information can be obtained from the probe. In the prior art systems, this positional information is acquired by attaching a part of a track or gantry to the item being tested, to which the probe can be attached and which provides a readout of the measuring position. The attachment of such gantry apparatus to the surface of an item such as an aircraft is difficult and time consuming.

### SUMMARY OF THE INVENTION

The present invention provides in a first aspect a probe for non-destructive testing of items, the probe being movable and rotatable over the surface of a test item and including a receiver for receiving a return signal from the non-destructive testing of the item and including displacement means for providing a displacement signal indicative of the spatial displacement of the probe over the test item as the probe is moved over the test item and the displacement means being arranged to provide information on the rotational orientation of the probe if the probe is rotated.

The displacement means may include a sensor mounted to the probe and being capable of providing the displacement signal and information on the rotational orientation. This information can be used to compensate for any rotation of the probe (which may occur naturally as the user moves the probe over the test item) from effecting the displacement information.

The sensor may be similar to sensors provided in computer “mice” for driving the computer graphical user interface (GUI). The sensor may be any type of mouse sensor and in a specific embodiment is an optical sensor (as used in so-called “optical mice”). Two sensors may be provided to enable provision of the orientation information.

In one embodiment, a pair of optical sensors are utilised in the probe. The pair of optical sensors are arranged to provide the orientation information.

The probe may advantageously have no need of a separate gantry or reference frame to enable the provision of positional information to an NDT processing system.

In another embodiment the probe comprises non-destructive-testing (NDT) data acquisition, processing and analysis electronics in one housing. The probe, together with a computer for data storage and data display, may form a complete NDT system. The probe may be operatively connectable with the computer using a single universal serial bus (USB) cable. In this case the USB cable may also be used to supply electrical power. Alternatively, the probe may be operatively connectable with the computer using a radio USB connection. This embodiment has a significant commercial advantage, as the probe is readily connectable to a typical standard computer. No modifications of the computer may be required and the computer does not need to be equipped with any special cards such as data acquisition cards. The probe may be connected to any typical standard PC computer via a USB port which has a significant commercial advantage. Further, the probe may be given a compact design similar to that of a computer mouse which has additional practical advantages.

As a variation of this embodiment, the probe may also comprise a computer memory for data storage in one housing. In this case a connection to an external computer may only be required for data transfer. The probe may also comprise a display and may form a complete NDT system.

In an alternative embodiment a system is provided for processing the signals provided by the probe. The system may be similar to the graphical user interface systems which are provided for processing positional information from computer mice.

The present invention provides in a second aspect a probe for non-destructive testing of items, the probe being arranged to provide positional information of displacement of the probe over the item, the probe being movable and rotatable over the surface of the item and including a displacement sensor means for providing a displacement signal indicative of the spatial displacement sensor means also being arranged to provide information on the rotational orientation of the probe if the probe is rotated.

The apparatus may include a suitable computing system programmed with suitable software to implement the probe position processing.

The present invention provides in a third aspect a non-destructive testing system comprising a probe as discussed above in combination with an apparatus for processing the probe signal as discussed above.

The present invention provides in a fourth aspect a probe for non-destructive testing of items, the probe comprising data acquisition, processing and analysis electronics in one housing and the probe forming, in combination with a typical standard computer, a useable NDT system.

The present invention provides in a fifth aspect a probe for non-destructive testing of an item, the probe is movable over a surface of the item and comprises:

a receiver for receiving a return signal for the non-destructive testing of the item,

a displacement means for providing a displacement signal indicative of a spatial displacement of the probe over the item as the probe is moved over the item and

a support structure for holding the displacement means and the receiver over the surface of the item,

wherein at least one of the displacement means and the receiver is moveable relative to at least a portion of the support structure whereby testing of an item having a curved surface is facilitated.

The receiver may be moveable relative to at least a portion of the support structure, but typically the displacement means is moveable relative to at least a portion of the support structure. Owing to the moveability of the displacement means relative to at least a portion of the support structure, a movement of the probe over the curved surface in a manner such that a substantially constant distance between the displacement means and the surface is largely maintained is facilitated. The probe typically comprises pitch/catch assemblies which include the receiver and an emitter for emitting a signal for the non-destructive testing of the item.

In a first embodiment of the fifth aspect of the present invention the support structure and the displacement means, which may comprise a housing, are coupled in a manner so that the displacement means is moveable relative to the entire support structure.

For example, the support structure may have three legs with feet that are arranged in a tripod arrangement. Such an arrangement has the particular advantage that the support structure may follow surface curvatures in a relatively easy and stable manner when the probe is moved over the surface. The displacement means may be positioned over a central portion of the area circumscribed by the feet. The test item may have a curved surface and the curvature may change across the surface. When the probe is moved over the surface and the three feet are in contact with the surface, the displacement means may, if the curvature is suitable, move up or down relative to the support structure to follow the curvature. It is therefore easier to meet the small distance tolerances required by a range of displacement means including optical devices such as those currently used in a so called “optical” computer mouse when curved surfaces are scanned.

The displacement means may include a housing and a displacement sensor such as an “optical” sensor positioned in the housing. The housing of the displacement means may have a lower surface and in this case the support structure typically is arranged to hold the lower surface of the housing on the surface of the item.

The probe typically has as a flexible coupling between the displacement means and the support structure. The flexible coupling may allow movement of the displacement means in any direction relative to the support structure. The coupling between the displacement means and the support structure may also comprise a guide that guides a movement of the displacement means relative to the support structure for example in a direction perpendicular to the surface under test.

The probe typically is arranged so that in use the three feet slide across the surface of a curved item, such as an aircraft panel, and the lower surface of the displacement means maintains contact with the surface even if the curvature of the surface is changing.

The probe may also comprise a handle portion that may be connected to the support structure. The connection may be pivotable and typically comprises a universal joint.

The handle portion typically is connected to the support structure so that the area circumscribed by support positions at which in use the support structure contacts the surface of the item has a diameter larger than the height of the pivotable connection over the area. This particular geometrical arrangement has the advantage that the likelihood of tipping the probe over when the probe is moved over the surface of the item is reduced.

In a second embodiment of the fifth aspect of the present invention the support structure comprises at least two portions which are moveable relative to each other and the displacement means is coupled to one of the portions. For example, the displacement means may be coupled to a first portion of the support structure so that the displacement means is stationary relative to the first portion of the support structure and moveable relative to a second portion of the support structure. The receiver may be coupled to the second portion so that the receiver and the displacement means are moveable relative to each other. As in this case the displacement means is moveable relative to the receiver, following of a curvature of a test sample is facilitated even if the curvature is changing.

Alternatively, the displacement means and the receiver may both be located in the second portion and the first portion may comprise a handle portion of the probe.

For example, the first and the second portions may be coupled by a coupling that includes a hinge or any type of articulated joint or a flexural joint that uses the compliance of material comprising the first and second portions. The first portion and the second portion of the support structure may be coupled in a manner so that the first and the second portions may be separated from each other. For example, the coupling may include a snap-fit connection in which one portion snap-fits into another portion. The second portion may comprise the pitch/catch assemblies and, as the first and the second portions are separable, the pitch/catch assemblies can be replaced in a relatively easy manner. To facilitate replacement of the second portion the pitch/catch assemblies, the second portion typically comprises snap-lock electrical connections for the pitch/catch assemblies.

The second portion with the pitch/catch assemblies and may also be arranged for operation as a stand-alone non-destructive testing probe. In this case the second portion may or may not comprise the displacement means.

The displacement means typically includes a displacement sensor such as an “optical” sensor.

The probe typically is arranged so that in use the probe slides across the surface of a curved item, such as an aircraft panel, and a lower surface of the displacement means maintains contact with the surface even if the curvature of the surface is changing. To further facilitate testing of curved items, the lower surface of the support structure may also include a curved surface portion.

In both embodiments of the fifth aspect the probe may comprise visually transparent materials. The probe typically is arranged so that a user can see through the transparent material on the surface of the item. This has the advantage that the user may be able to see the area that is tested or an area close to the area that is tested. For example, the support structure may comprise the transparent material. In one specific example the second portion of the support structure comprises the transparent material.

The probe may also comprise pointers or any type of markings that indicates at which position the pitch/catch assemblies are located and therefore in use indicates a test area. For example, the markings may be “datum” markings.

The present invention provides in a sixth aspect a probe for non-destructive testing of an item, the probe is movable over a surface of the item and comprises:

a receiver for receiving a return signal for the non-destructive testing of the item and

a displacement means for providing a displacement signal indicative of a spatial displacement of the probe over the item as the probe is moved over the item and

a support structure for holding the displacement means over the surface of the item,

such that, when the support structure is moved over the surface of the item, a substantially constant distance is maintained between the displacement means and the surface of the item.

The support structure and the displacement means typically are coupled in a manner so that the displacement means is moveable relative to at least a portion of the support structure.

The present invention provides in a seventh aspect a probe for non-destructive testing of an item, the probe is movable over the surface of the item and comprises:

a receiver for receiving a return signal from the non-destructive testing of the item,

a displacement means for providing a displacement signal indicative of a spatial displacement of the probe over the item as the probe is moved over the test item and

a support structure for supporting the displacement means over the surface of the item

wherein the support structure comprises legs that are arranged in a tripod arrangement.

The present invention provides in an eights aspect a probe for non-destructive testing of an item, the probe being movable over the surface of the item and comprising

a receiver for receiving a return signal from the non-destructive testing of the item,

a displacement means for providing a displacement signal indicative of a spatial displacement of the probe over the item as the probe is moved over the item and

a support structure for supporting the displacement means over the surface of the item and

wherein the support structure comprises two portions that are moveable relative to each other.

The invention will be more fully understood from the following description of specific embodiments. The description is provided with reference to the accompanying drawings.

### BRIEF DESCRIPTION OF THE DRAWINGS

FIG. 1 is a schematic diagram of a system in accordance with an embodiment;

FIG. 2 is a cross-sectional view through a NDT probe in accordance with an embodiment;

FIG. 3 is a schematic diagram of a probe in accordance with an embodiment;

FIG. 4 is a cross-section through a prior art pitch/catch probe for NDT testing;

FIG. 5 shows a schematic representation of a probe for non-destructive testing in accordance with an embodiment of the present invention;

FIGS. 6-7 show views of portions of the probe shown in FIG. 5;

FIG. 8 shows a top-view of a probe for non-destructive testing in accordance with another embodiment of the present invention and

FIG. 9 shows a bottom view of the probe also shown in FIG. 8.

### DETAILED DESCRIPTION OF SPECIFIC EMBODIMENTS

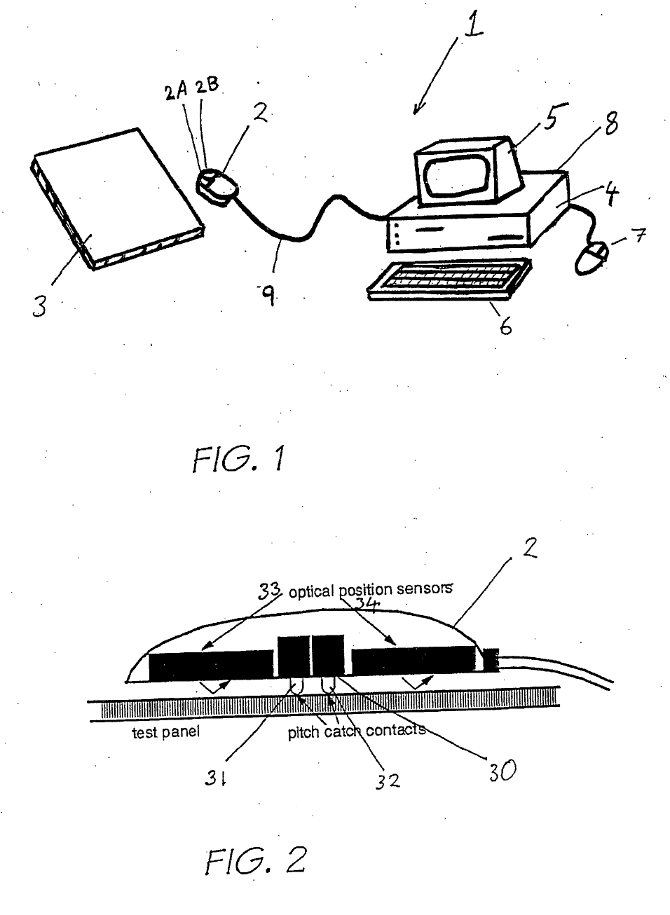

Referring to FIG. 1, there is illustrated a non-destructive testing apparatus in accordance with an embodiment, generally designated by reference numeral 1.

The apparatus includes a NDT probe 2 in accordance with an embodiment. The probe 2 is arranged to be passed over a test sample 3 and to provide an acoustic vibration signal of a drive frequency within the range of 5 to 70 kHz to the sample 3 and receive a return signal to be processed by the computing system 8 to provide data on any faults in the test sample 3.

In operation, the test sample will usually be a part of equipment being tested, such as an aeroplane, for example.

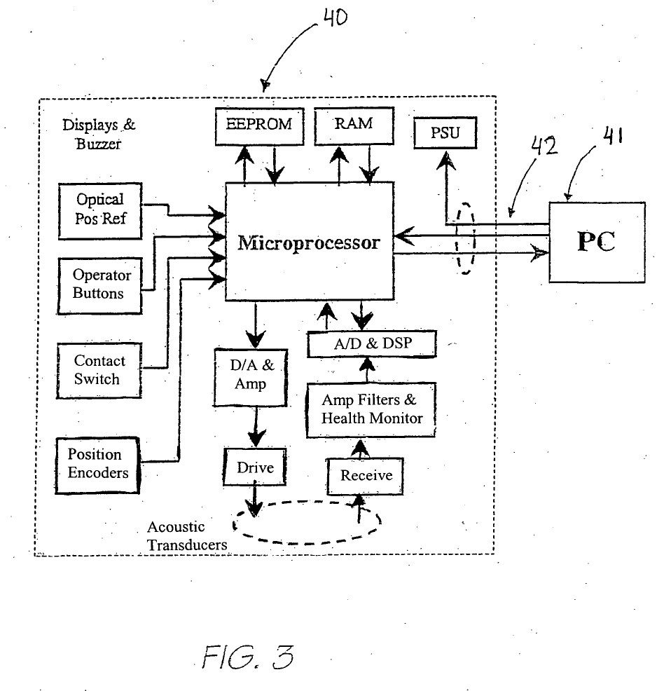

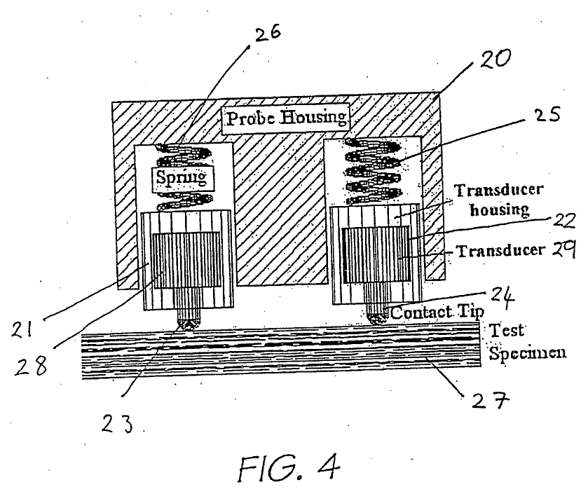

Referring to FIG. 2, the probe 2 comprises a pitch/catch arrangement 30. The pitch/catch arrangement 30 includes pitch/catch assemblies 31 and 32 which are equivalent to the pitch/catch assemblies 21 and 22 which are described in the preamble with reference to FIG. 4. The operation of the pitch/catch arrangement 30 of the probe 2 is the same as that of the prior art pitch/catch arrangement and no further description will be given.

In addition to the pitch/catch arrangement 30, the probe 2 also mounts displacement means 33 and 34. In this embodiment, the displacement means 33 and 34 comprise two optical systems 33 and 34 which are equivalent to those used in the so-called “optical” computer mouse. These optical systems operate by continuously forming an image of a small area of the test surface 3 beneath the probe 2. As the image is updated two-dimensional cross correlation is calculated using the natural “texture” of whatever is in the image. The result of this is a number which expresses how far the probe has moved between images. By utilising two of the optical systems 33 and 34 a vector for the movement of the probe 2 can be calculated. A computer 4 (see later) calculates this vector from the displacement signal provided by the optical systems. Because there are two optical systems, orientation information is provided enabling the vector to be calculated.

Note that the probe provides displacement information and that the processing to provide the positional information takes place in computing system 3 (to be described later).

The probe 2 also has “mouse buttons” 2A and 2B. These are associated with sensors so that when the buttons 2A, 2B are actuated a signal is sent back to computing system 8.

In use, a user of the probe 2 sets a “datum” on the test sample 3 from which all dimensional information may be mapped. The probe 2 can then be moved anywhere and the NDT reading taken, or the readings can be taken continuously as the probe is moved (these various options can be implemented using the probe buttons). If the probe 2 is lifted off the test piece 3 clicking on the datum re-establishes the co-ordinate system. The calculation of a vector rather than simply the distance the probe 2 has moved means that the user can rotate the mouse without distorting the co-ordinate system.

The data may comprise a reflective detector spot or a number of reflective detector spots on the panel and an LED/detector on the probe. Reflective spot provides point of reference. The spot may be matt, depending upon whether the panel has a shiny surface.

Note that normal mouse function is retained in mouse 7 connected to the computing system, and control can be switched back and forth between the probe 2 and the mouse 7 according to user demand.

As well as the probe 2 the system also includes a computing system 8 including a computer 4, display 5, keyboard 6 and mouse 7. Software is provided for the computing system 8 to process the signals from the optical sensors 33 and 34 and also the signals from the pitch/catch probe arrangement 30.

The computing system 8 may process the signals from the pitch/catch probe 30 in any conventional way known in the prior art, to provide information on defects within the test sample 3 as the probe 2 is passed over the test sample. Preferably, however, the signals are processed in accordance with the method of the invention described in the applicants co-pending application entitled “Method and Apparatus for Carrying Out Non-Destructive Testing of Materials”, filed on the same day as the present application, and the disclosure of which is incorporated herein by reference.

Software may be provided to control a computing system 8 to process the displacement signals from the optical systems 33 and 34 to provide position information as discussed above. This position information can be stored in the computer along with the result of the processing of the pitch/catch signals, so that a positional map of the sample may be provided showing any defects therein, on display 5.

Referring to FIG. 3, there is illustrated a non-destructive testing (NDT) system in accordance with an embodiment. The system includes a NDT probe 40 and a PC computer 41. The probe 40 comprises all NDT data acquisition, processing and analysis electronics in one housing. The PC computer 41 functions to store and display data. The probe is operatively connected with the computer using a single USB cable 42. The probe can be connected to any typical standard PC computer via a USB port which gives the probe a significant commercial advantage. In this case the USB cable may also be used to supply electrical power.

Alternatively, the probe may be battery-powered and the data transfer between probe 40 and computer 42 may be wireless in which case the device does not need a USB cable connection.

In operation, the test sample will usually be a part of equipment being tested, such as an aeroplane, for example.

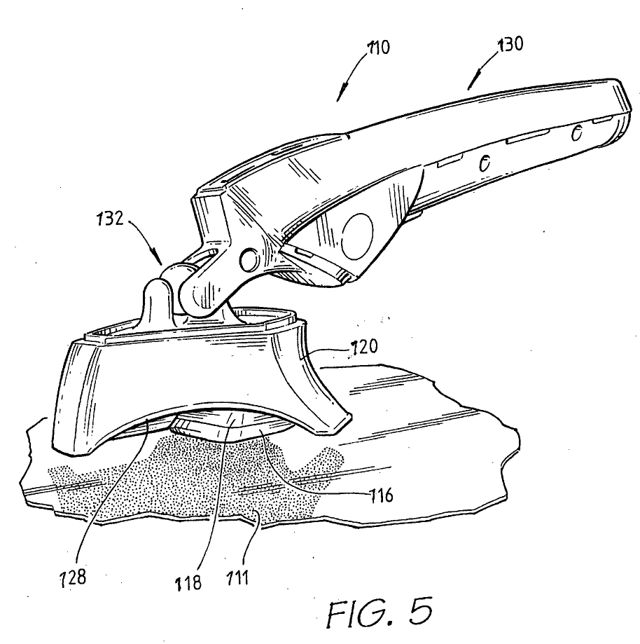

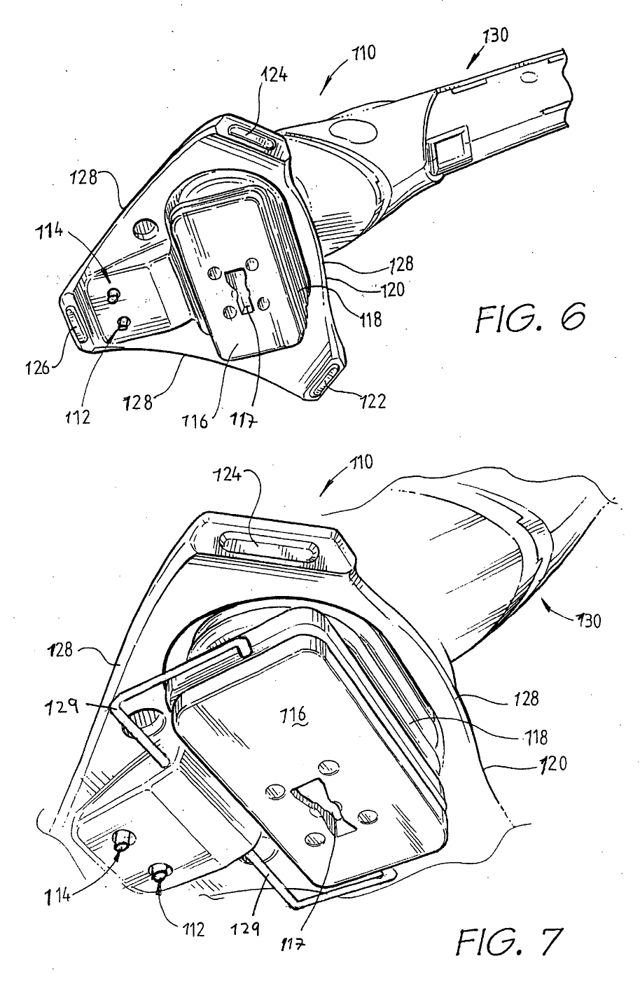

Referring now to FIGS. 5 to 7, there is illustrated a probe for non-destructive testing in accordance with another embodiment of the present invention, generally designated by reference numeral 110.

The probe 110 is arranged to be passed over a test sample 111, which shows a reflection of the probe, and to provide an acoustic vibration excitation of a drive frequency within the range of 1 to 70 kHz to the sample 111 and receive a return signal to be processed by the computing system (not shown) to provide data on any faults in the test sample. The acoustic vibration excitation may be of single frequency or may be a broad-band excitation such as a band-limited broad-band excitation. In operation, the test sample will usually be a part of equipment being tested, such as an aeroplane, for example. A return signal detected from a damaged test sample is compared with that from a “good” test sample (to give a reference signal) to determine the extent of any damage to the test sample. In one embodiment of the present invention the probe 110 is arranged to store reference signals so that the same reference signal can be used for continued testing of a tests item or for different test items of the same type.

The probe 110 comprises pitch/catch assemblies 112 and 114 of the probe 110. The pitch/catch assemblies 112 and 114 assemblies include contact tips which are spring loaded to contact a test sample. One of the assemblies 112 acts as a driver and the other as a detector. The available drive frequency range is wide, typically 1 to 70 kHz. The drive signal is generally a short wave train, up to 6 cycles of sinusoid at a user selected frequency within the above range.

In addition to the pitch/catch assemblies 112 and 114, the probe 110 comprises a displacement device 116 that provides information about the displacement of the probe when the probe is moved over the surface of a test item. In this embodiment, the displacement device 116 comprises an optical system in a housing and the optical system is equivalent to those used in the so-called “optical” computer mouse. The housing has a lower surface having an opening 117 through which the optical sensor operates.

The displacement device 116 is mounted by a flexible mounting 118 to a support structure 120. In this embodiment, the flexible mounting 118 comprises a resilient material that allows movement of the displacement device 116 in any direction relative to the support structure 120. In this case the resilient material is a rubber type material connecting the support structure 120 with the housing of the displacement device 116. Alternatively, however, the flexible mounting may be a mechanical arrangement comprising parts which function as a whole so that the mounting is flexible.

The support structure 120 has three sliding feet 122, 124 and 126 which form part of a tripod arrangement. The sliding feet 122, 124 and 126 which are linked by a bridge portion that is a part of the support structure 120. The displacement device is positioned at a central portion of the area circumscribed by the three feet. The support structure has arc-shaped cut-outs 128.

In this embodiment, a handle portion 130 is connected to the support structure 120 by a universal joint 132 that allows pivotable movement about itself in all directions. The universal joint is covered by a flexible rubber sleeve which is not shown. In one embodiment, the handle portion 130 is arranged for connection to an extension pole or is extendable which has advantages when the test item is not easily accessible (eg areas of an aircraft which are difficult to reach). In an alternative embodiment the handle is fully removable so that the support structure 120 can be used independently in areas having restricted access. In this instance the support structure would be connected to the handle by means of an extension cable.

In use the probe 110 may be moved over the surface of the test item, such as an aircraft panel, having a curved surface and, for example, the curvature of the surface may change across the surface. The three feet 122, 124 and 126 are sliding on the surface and because of the tripod arrangement it may be possible to follow the curvature of the surface while at the same time all of the three sliding feet are in contact with the surface of the test item. The displacement device 116 is flexibly mounted on the support structure 120 and in use the lower surface of housing of the displacement device is in contact with the surface. Due to the flexible mounting, contact of the lower surface of the housing with the surface of the test item can be maintained even if the curvature of the surface changes as the displacement means can move (ie. up or down) relative to the support structure 120. It is therefore possible to obtain relaiable displacement information even if the probe is moved over a curved surface having a changing curvature.

The probe is arranged so that in use the universal joint 132 is at a relatively low level over the surface of a test item. In this embodiment, the universal joint 132 is positioned so that the distance between the sliding feet 122, 124 and 126 is larger than the height of the universal joint 132 over the surface of the test item. This arrangement has the advantage that it is possible to move the probe over the surface of the test item in a relatively stable manner and the likelihood of tipping is reduced.

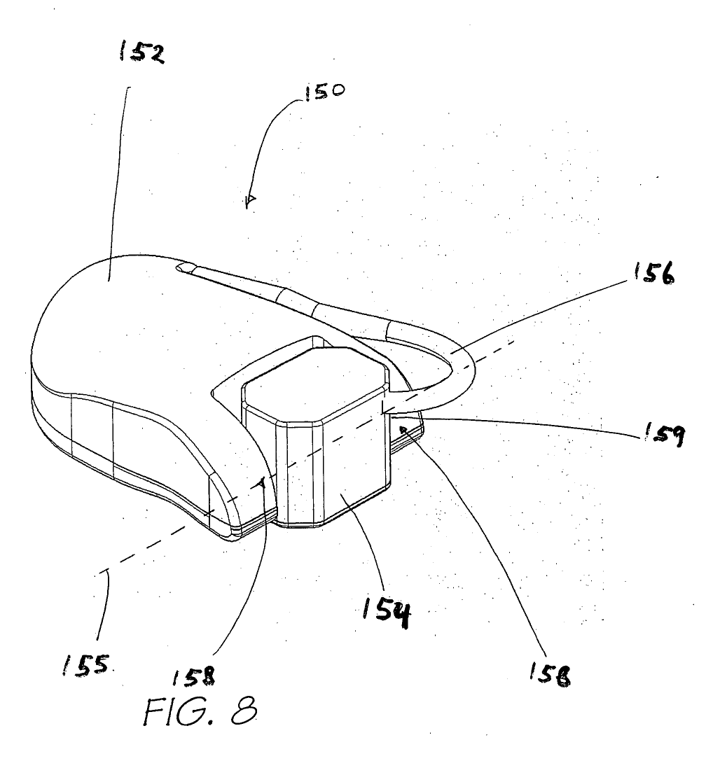

In the embodiment shown in FIG. 7 the probe also comprises a guide which is in this example provided in form of a bracket 129. The bracket 129 guides the displacement device 116 so that it is moveable in a direction towards, or away from, the surface of the test item and a movement in another direction is restricted.

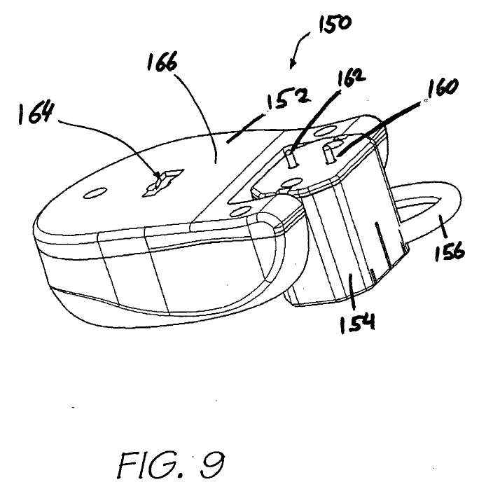

Referring now to FIGS. 8 and 9, a probe for non-destructive testing according to another embodiment of the present invention is now described. The probe 150 comprises a first portion 152 and a second portion 154. The first portion 152 and the second portion 154 are movable relative to each other. The first portion 152 and the second portion 154 are also connected by an electrical cable 156. In this embodiment the second portion 54 is coupled to the first portion 152 in a manner so that the second portion 154 is pivotable about an axis 155.

In this example, the second portion 154 is coupled to the first portion 152 by a snap fit. The second portion 154 and the first portion 152 therefore are separable. The electrical cable 156 also has a snap fit 159 which allows disconnection in a relatively easy manner.

In this embodiment the second portion 154 comprises pitch/catch assemblies 160 and 162. The pitch catch assemblies 160 and 162 are analogous to pitch/catch assemblies 112 and 114 discussed above. As the second portion 154 is removable from the first portion 152, it is relatively easy to replace the second portion 154 or the pitch/catch assemblies of the second portion 154. The first portion 152 comprises a displacement device 164 which in this embodiment is analogous to displacement device 116 discussed above.

As in this embodiment the second portion 152, which include the pitch/catch assemblies, is movable about axis 155 and relative to the first portion 152, which includes the displacement device 164, it is possible to follow a curved surface of a test item so that a predetermined distance between the displacement device 164 and the surface of the curved test item is largely maintained. Further, the first portion 152 also includes a curved lower surface 166 which further facilitates testing of the curved test item.

In this embodiment the second portion 154 is composed of a transparent material such as a transparent polymeric material. This has the advantage that it is possible for a user to see the test area or an area that is close to the test area. In addition, the second portion 154 includes in this embodiment markings, in this case provided in the form of datum markings, which indicate the position of the pitch catch assemblies 160 and 162.

The probes 110 and 150 includes electronic components analogous to those shown in FIG. 3 and operates in the same manner as illustrated by the schematic block diagram of FIG. 3.

In this embodiment the pitch/catch assemblies 112 and 114, are stationary relative to the second portion 154. It will be appreciated, that alternatively the pitch/catch assemblies may be movable relative to the second portion 154. Further, the second portion 154 may also include the displacement device such as displacement device 164. In a variation of this embodiment the first portion 152 comprises the pitch/catch assemblies and the second portion 154 comprises the displacement device. Further, it will also be appreciated that the first and second portions may be coupled to each other in any manner that allows movability of the first portion 152 relative to the second portion 154. For example, coupling may be effected using a universal joint or any other type of joint. Additionally or alternatively the second portion may also be movable about any axis other than axis 155. Further, the coupling may include a hinge so that the first portion 152 and the second portion 154 are hingedly connected.

In the above description, the probe incorporates a pitch/catch arrangement. It will be appreciated that the present invention is not limited to use of a pitch/catch arrangement. Any NDT sensor arrangement which can be incorporated in the probe may be utilised (e.g. ultrasonic pulse echo, eddy current, mechanical impedance).

The particular embodiment of the probe described above utilises optical arrangements for providing positional information. It will be appreciated that the present invention is not limited to optical arrangements, and any sensor arrangement which enables the provision of positional information from motion of the probe may be utilised. For example, an arrangement such as that of a conventional computer ball-mouse may be utilised for this purpose.

The probe described above is particularly suitable for use in non-destructive testing. The probe is not limited to the NDT field, however. Any process or system which requires the input of positional information from a probe could utilise the probe of the present invention.

Further, the probe may also comprise computer memory for data storage in one housing. In this case a connection to an external computer may only be required for data transfer. The probe may also comprise a display and may form a complete NDT system.

1. A probe for non-destructive testing of items, the probe being movable and rotatable over the surface of a test item and including a receiver for receiving a return signal from the non-destructive testing of the item and including displacement means for providing a displacement signal indicative of the spatial displacement of the probe over the test item as the probe is moved over the test item and the displacement means being arranged to provide information on the rotational orientation of the probe if the probe is rotated.

2. The probe as claimed in claim l, wherein the displacement means includes a sensor mounted to the probe and being capable of providing the displacement signal.

3. The probe as claimed in claim 1, wherein the sensor is equivalent to sensors provided in computer mice.

4. The probe as claimed in claim 3, wherein the sensor is an optical sensor similar to those utilised in computer mice.

5. The probe as claimed in claim 2 wherein the sensor is one of two or more sensors and wherein the displacement means is arranged so that information on the rotational orientation of the probe is derived from the movement of the sensor relative to the test item.

6. The probe as claimed in claim 1 comprising non-destructive testing (NDT) data acquisition, processing and analysis electronics in one housing.

7. The probe as claimed in claim 6 wherein the probe, together with a computer for data storage and data display, forms a complete NDT system.

8. The probe as claimed in claim 6 wherein the probe is operatively connectable with the computer using a single USB cable.

9. The probe as claimed in claim 7 wherein the probe is operatively connectable with the computer using a radio USB connection.

10. The probe as claimed in claim 6 wherein the probe comprises computer memory for data storage in one housing.

11. The probe as claim in claim 10 wherein the probe comprises a display in one housing and forms a complete NDT system.

12. An apparatus for processing a signal from a probe as claimed in claim 1, to provide data on the position of the probe as it moves over a test surface.

13. A non-destructive testing system comprising a probe as claimed in claim 1 and an apparatus for processing a signal from the probe to provide data on the position of the probe as it moves over a test surface.

14. A probe for non-destructive testing of items, the probe being arranged to provide positional information of displacement of the probe over the item, the probe being movable and rotatable over the surface of the item and including a displacement sensor means for providing a displacement signal indicative of the spatial displacement of the probe over the test item, the displacement sensor means also being arranged to provide information on the rotational orientation of the probe if the probe is rotated.

15. The probe as claimed in claim 14 comprising data acquisition, processing and analysis electronics in one housing and the probe forming, in combination with a typical standard computer, a useable NDT system.

16. A probe for non-destructive testing of an item, the probe is movable over a surface of the item and comprises:
a receiver for receiving a return signal for the non-destructive testing of the item,
a displacement means for providing a displacement signal indicative of a spatial displacement of the probe over the item as the probe is moved over the item and
a support structure for holding the displacement means and the receiver over the surface of the item,
wherein at least one of the displacement means and the receiver is moveable relative to at least a portion of the support structure whereby testing of an item having a curved surface is facilitated.

17. The probe as claimed in claim 16 wherein the displacement means is moveable relative to at least a portion of the support structure.

18. The probe as claimed in claim 16 comprising pitch/catch assemblies which include the receiver and an emitter for emitting a signal for the non-destructive testing of the item.

19. The probe as claimed in claim 16 wherein the support structure and the displacement means are coupled in a manner so that the displacement means is moveable relative to the entire support structure.

20. The probe as claimed in claim 16 wherein the displacement means includes a housing having a lower surface and the support structure is arranged to hold the lower surface of the housing on the surface of the test item.

21. The probe as claimed in claim 16 having a flexible coupling that couples the displacement means to the support structure.

22. The probe as claimed in claim 16 wherein the support structure has three legs with feet that are arranged in a tripod arrangement.

23. The probe as claimed in claim 22 arranged so that in use the three feet slide across the surface of a curved test item and a lower surface of the displacement means maintains contact with the surface even if the curvature of the surface is changing.

24. The probe as claimed in claim 16 further comprising a handle portion.

25. The probe as claimed in claim 24 wherein the support structure and the handle portion are connected by a pivotable connection.

26. The probe as claimed in claim 25 wherein the connection comprises a universal joint.

27. The probe as claimed in claim 24 wherein the handle portion is connected to the support structure so that the area circumscribed by support positions at which in use the support structure contacts the surface of the test item has a diameter larger than the height of the pivotable connection over the area.

28. The probe as claimed in claim 16 wherein the support structure comprises at least two portions which are moveable relative to each other and the displacement means is coupled to one of the portions.

29. The probe as claimed in claim 28 wherein the displacement means is coupled to a first portion of the support structure so that the displacement means is stationary relative to the first portion of the support structure and moveable relative to a second portion of the support structure.

30. The probe as claimed in claim 28 wherein the receiver is coupled to the second portion so that the receiver and the displacement means are moveable relative to each other.

31. The probe as claimed in claim 28 wherein the displacement means and the receiver are both located in the second portion and the first portion may comprise a handle portion of the probe.

32. The probe as claimed in claim 28 wherein the first and the second portions are coupled by a coupling that includes a hinge.

33. The probe as claimed in claim 28 wherein the first and the second portions are coupled by a coupling that includes an articulated joint.

34. The probe as claimed in claim 28 wherein the first and the second portions are coupled by a coupling that includes a flexural joint that uses the compliance of material comprising the first and second portions.

35. The probe as claimed in claim 28 wherein the first portion and the second portion of the support structure are coupled in a manner so that the first and the second portions may be separated from each other.

36. The probe as claimed in claim 35 comprising a snap-fit connection for coupling the fist and the second portions.

37. The probe as claimed in claim 28 wherein the second portion comprises pitch/catch assemblies.

38. The probe as claimed in claim 37 being arranged for operation as a stand-alone non-destructive testing probe.

39. The probe as claimed in claim 28 comprising an optical sensor.

40. The probe as claimed in claim 28 being arranged so that in use the probe slides across the surface of a curved item and a lower surface of the displacement means maintains contact with the surface even if the curvature of the surface is changing.

41. The probe as claimed in claim 40 wherein the lower surface is curved.

42. The probe as claimed in claim 16 comprising visually transparent materials.

43. The probe as claimed in claim 42 being arranged so that a user can see through the transparent material onto the surface of the item.

44. The probe as claimed in claim 16 comprising markings that indicate at which position the pitch/catch assemblies are located.

45. A probe for non-destructive testing of an item, the probe is movable over a surface of the item and comprises:
a receiver for receiving a return signal for the non-destructive testing of the item and
a displacement means for providing a displacement signal indicative of a spatial displacement of the probe over the item as the probe is moved over the item and
a support structure for holding the displacement means over the surface of the item,
such that, when the support structure is moved over the surface of the item, a substantially constant distance is maintained between the displacement means and the surface of the item.

46. The probe as claimed in claim 45 wherein the support structure and the displacement means typically are coupled in a manner so that the displacement means is moveable relative to at least a portion of the support structure.

47. A probe for non-destructive testing of an item, the probe is movable over the surface of the item and comprises:
a receiver for receiving a return signal from the non-destructive testing of the item,
a displacement means for providing a displacement signal indicative of a spatial displacement of the probe over the item as the probe is moved over the test item and
a support structure for supporting the displacement means over the surface of the item
wherein the support structure comprises legs that are arranged in a tripod arrangement.

48. A probe for non-destructive testing of an item, the probe being movable over the surface of the item and comprising
a receiver for receiving a return signal from the non-destructive testing of the item,
a displacement means for providing a displacement signal indicative of a spatial displacement of the probe over the item as the probe is moved over the item and
a support structure for supporting the displacement means over the surface of the item and
wherein the support structure comprises two portions that are moveable relative to each other.
